(19) United States
(12) Patent Application Publication
(10) Pub. No.: US 2005/0073658 A1
(43) Pub. Date: Apr. 7, 2005

(54) Projector and light-shielding heat-dissipating mask for the same

(76) Inventors: Kuo-ching Chang, Taipei (TW); Hsiu-ming Chang, Taipei (TW); Chia-jui Lin, Taipei (TW)

Correspondence Address: BIRCH STEWART KOLASCH & BIRCH, PO BOX 747, FALLS CHURCH, VA, 22040-0747, US

(21) Appl. No.: 10/944,805

(22) Filed: Sep. 21, 2004

(30) Foreign Application Priority Data
Oct. 1, 2003 (TW) 92127174

(51) Int. Cl. G03B 21/16

(52) U.S. Cl. 353/52

(57) ABSTRACT

The present invention discloses a light-shielding heat-dissipating mask for a projector. The projector has a light source, a fan, and an air vent. The light-shielding heat-dissipating mask comprises a plurality of metal sheets which are positioned at the air vent for dissipating the heat generated by the light source and decreasing the possibility of the light emitted form the light source escaping out of the air vent.

### BACKGROUND OF THE INVENTION

(a) Field of the Invention

The present invention relates to a projector, and more particularly, to a light-shielding mask for a projector.

(b) Description of Related Art

Electronic signal image projectors, which have been developed extensively since 1990, have the characteristics of being easy to carry and adjust compared with overhead projectors or slide projectors. An electronic signal image projector, similar to an overhead projectors or a slide projector, uses a highly illuminant light bulb as a light source to project an image onto a white screen or wall. The display devices used in the projectors of nowadays include cathode ray tubes (CRT), high temperature polysilicon transmissive LCD panels, and digital light processing (DLP) elements.

In the design of an electronic signal image projector, it is important to find the solution of the heat-dissipating problem of a light source. A fan is generally provided on the right, left or rear side of the light source for cooling as shown in FIG. 1A and FIG. 1B. Referring to FIG. 1A and FIG. 1B, a mask 13 or 13a is provided at the air vent 14 of a projector to prevent the light emitted from the light source 11 from escaping out of the air-venting side of a fan 12 through the air vent 14 of the projector. However, since the mask 13 or 13a is made of plastic material, which requires a draft angle, its thickness tends to be not small. Therefore, the mask 13 or 13a is subject to some limitations of design.

For the above reason, such a mask 13 or 13a of prior art has the following disadvantages: the air flow impedance during heat-dissipation process being large, vent temperature being high, fan efficiency being low, and noises existing during cooling process.

Thereupon an increasing need for the solution of the above-mentioned problems in designing a projector is desired, including reducing the impedance caused by masks, enhancing the cooling efficiency, decreasing the vent temperature, and reducing noises.

### BRIEF DESCRIPTION OF THE DRAWINGS

FIG. 1A shows a partial schematic view of a light-shielding mask of a prior art projector;

FIG. 1B shows a partial schematic view of a light-shielding mask of a prior art projector;

FIG. 2A shows a partial schematic view of a light-shielding heat-dissipating mask for a projector according to one embodiment of the present invention;

FIG. 2B shows a partial schematic view of a light-shielding heat-dissipating mask for a projector according to one embodiment of the present invention;

FIG. 2C shows a partial schematic view of a light-shielding heat-dissipating mask for a projector according to one embodiment of the present invention;

FIG. 3A shows a partial schematic view of a light-shielding heat-dissipating mask for a projector according to one embodiment of the present invention;

FIG. 3B shows a partial schematic view of a light-shielding heat-dissipating mask for a projector according to one embodiment of the present invention;

FIG. 3C shows a partial schematic view of a light-shielding heat-dissipating mask for a projector according to one embodiment of the present invention;

FIG. 4A shows a partial schematic view of a light-shielding heat-dissipating mask for a projector according to one embodiment of the present invention;

FIG. 4B shows a partial schematic view of a light-shielding heat-dissipating mask for a projector according to one embodiment of the present invention;

FIG. 4C shows a partial schematic view of a light-shielding heat-dissipating mask for a projector according to one embodiment of the present invention;

FIG. 5 shows a schematic view of a projector having a light-shielding heat-dissipating mask according to one embodiment of the present invention;

FIG. 6A shows a partial schematic view of part of a projector having a light-shielding heat-dissipating mask according to another embodiment of the present invention;

FIG. 6B shows a partial schematic view of part of a projector having a light-shielding heat-dissipating mask according to further another embodiment of the present invention.

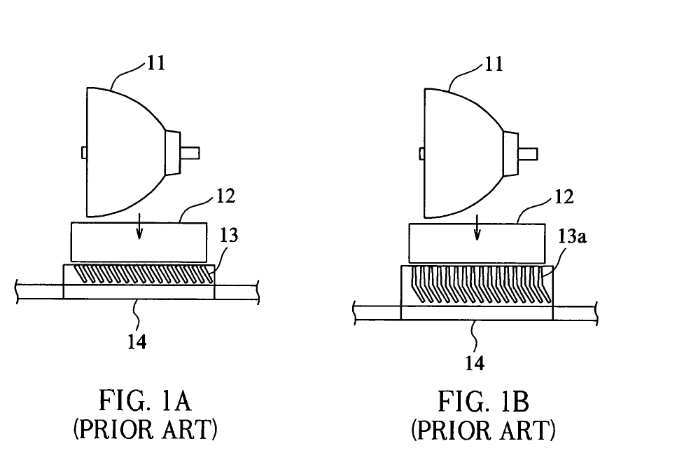

### SUMMARY OF THE INVENTION

An object of the present invention is to provide a thin light-shielding heat-dissipating mask for a projector, which is capable of reducing the flow impedance effectively and reducing noises during heat-dissipating process, which also has a good thermal conductivity so as to dissipate the heat within the projector quickly and thereby improves the fan efficiency.

Another object of the present invention is to provide a projector equipped with a light-shielding heat-dissipating mask of the present invention, which has a low vent temperature and a high heat-dissipating efficiency.

Further another object of the present invention is to provide a projector equipped with a light-shielding heat-dissipating mask and a heat pipe of the present invention, which has a low vent temperature and a high heat-dissipating efficiency.

The light-shielding heat-dissipating mask for a projector having a light source, a fan, and an air vent according to the first embodiment of the present invention comprises a plurality of metal sheets fixed on an air vent of the projector for dissipating the heat generated by the light source and decreasing the possibility of the light escaping out of the air vent.

The light-shielding heat-dissipating mask for a projector having a light source, a fan, and an air vent according to the second embodiment of the present invention comprises a plurality of metal sheets fixed on an air vent of the projector for dissipating the heat generated by the light source and decreasing the possibility of the light escaping out of the air vent, wherein the metal sheets are connected to at least one heat-dissipating end of a heat pipe.

The projector according to the first embodiment of the present invention comprises a casing, an imaging unit, an illuminating unit, a fan, an air vent, and a light-shielding heat-dissipating mask. The imaging unit, positioned in the casing, includes at least one light valve and circuitry for controlling the imaging of the light valve. The illuminating unit, positioned in the casing, includes a light source and an optical element for guiding the light from the light source to the imaging unit. The fan is positioned around the light source, and its air-inlet side faces the light source so as to dissipate the heat generated by the light source. The air vent is positioned on the casing and faces the air-outlet side of the fan. The light-shielding heat-dissipating mask, comprising a plurality of metal sheets, is positioned immediately adjacent to the fan for dissipating the heat generated by the light source and decreasing the possibility of the light escaping out of the air vent.

The projector according to the second embodiment of the present invention comprises a casing, an imaging unit, an illuminating unit, a first fan, a second fan, a first air vent, a second air vent, a first light-shielding heat-dissipating mask, a second light-shielding heat-dissipating mask, and at least one heat pipe, wherein the imaging unit, positioned in the casing, includes at least one light valve and circuitry for controlling the imaging of the light valve; the illuminating unit, positioned in the casing, includes a light source and an optical element for guiding the light from the light source to the imaging unit; the first fan is positioned around the light source, and its air-inlet side faces the light source so as to dissipate the heat generated by the light source; the first air vent is positioned on the casing and faces the air-outlet side of the first fan; the first light-shielding heat-dissipating mask, comprising a plurality of metal sheets, is positioned immediately adjacent to the first fan for dissipating the heat generated by the light source and decreasing the possibility of the light escaping out of the first air vent; the second air vent is positioned on the casing and far away from the first air vent; the second fan is positioned around the second air vent with its air-outlet side facing the second air vent; the second light-shielding heat-dissipating mask, comprising a plurality of metal sheets, is positioned immediately adjacent to the second fan for dissipating the heat generated by the light source and decreasing the possibility of the light escaping out of the second air vent; the heat-dissipating end of the heat pipe is connected to the first and the second light-shielding heat-dissipating mask, and its heat-absorbing end is positioned in the high-temperature region within the casing.

The advantages of the present invention include: (1) since the light-shielding heat-dissipating mask is manufactured without the consideration of draft angle, the mask formed in such a way is thin, and the flow impedance resulting from air is low. Thus the temperature around the air vent is reduced due to an increased amount of the exhausted air; (2) the light-shielding heat-dissipating mask made of metal has a good thermal conductivity and is capable of conducting heat to far end instantly with the aid of a heat pipe, which implies simultaneous functions of heat-dissipation and light-shielding; (3) since the light-shielding heat-dissipating mask is made of metal, it can provide the function of electromagnetic interference (EMI) protection.

### DETAILED DESCRIPTION OF THE PREFERRED EMBODIMENT

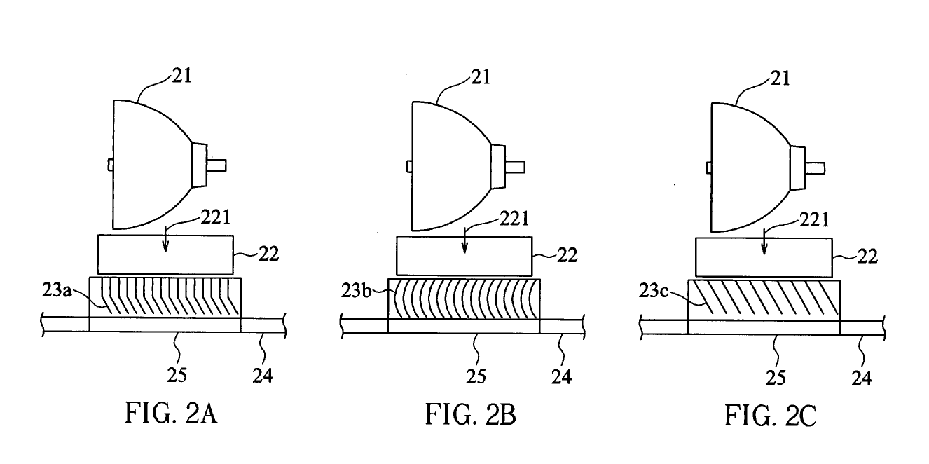

Embodiments of the present invention will be described in detail by referring to FIG. 2A to FIG. 6B in the following.

Referring now to FIG. 2A, in a first embodiment, the light-shielding heat-dissipating mask 23a for a projector according to the present invention, comprising a plurality of metal sheets (aluminum sheets in this embodiment) which have a V-shaped profile and are positioned in the same direction with a fixed gap between adjacent sheets, is positioned immediately adjacent to the fan 22 below the light source 21 of the projector, wherein the air-inlet side of the fan 22 faces the light source 21 for dissipating the heat generated by the light source 21.

In the first embodiment, the heat generated by the light source 21 is exhausted out of the air vent 25 of the casing 24 of the projector in the arrow direction 221 as the fan 22 is operating. The heat is directed to dissipate rapidly from the air vent 25 through the gap between adjacent sheets of the light-shielding heat-dissipating mask 23a. Furthermore, the light emitted from the light source won't scatter to outside via the air vent 25 owing to the bending of V-shaped profile of each metal sheet. It should be noted that the metal-made light-shielding heat-dissipating mask 23b of an arc profile shown in FIG. 2B and the metal-made light-shielding heat-dissipating mask 23c of a linear profile shown in FIG. 2C are also effective in heat-dissipation and light-shielding in addition to the light-shielding heat-dissipating mask 23a of the V-shaped profile.

In other words, as long as the objectives that the heat exhausted from the light source 21 is directed to dissipate from the air vent 25 with the aid of the fan 22 by using the metal-made light-shielding heat-dissipating mask 23a as well as the light emitted from the light source 21 won't scatter to outside via the air vent 25 owing to the bending angle and the configuration of each metal sheet of the light-shielding heat-dissipating mask, the profile of each metal sheet is not limited to the three types mentioned above.

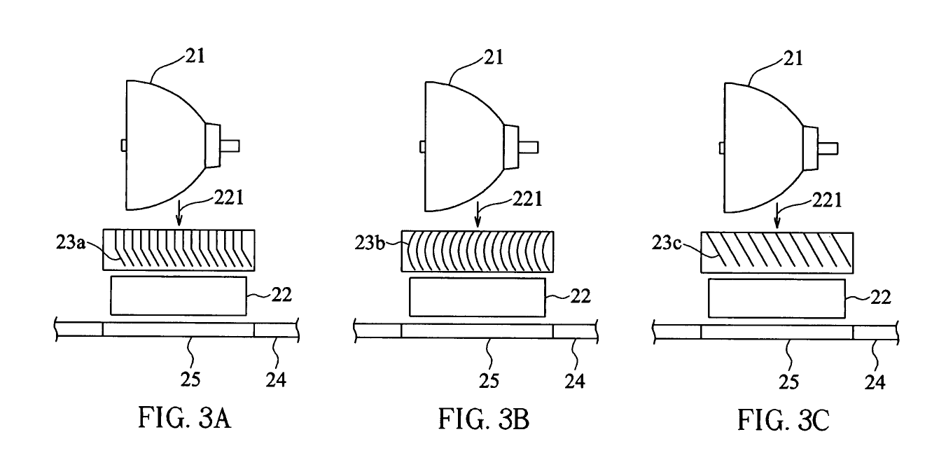

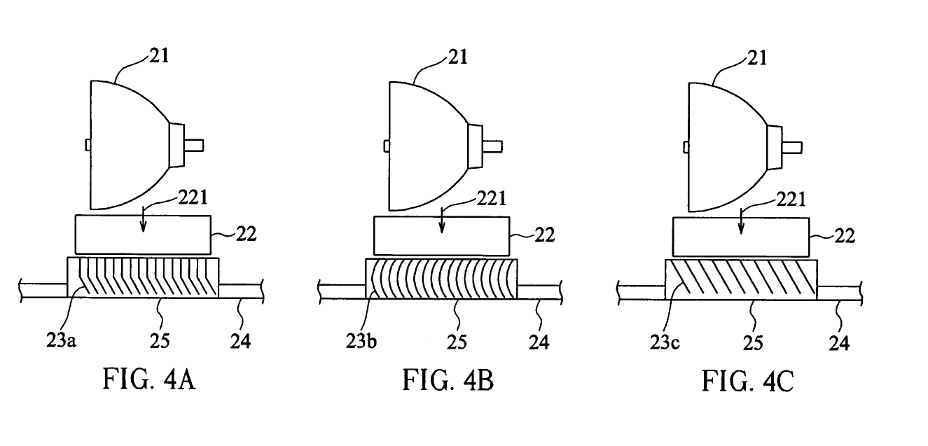

Moreover, the relative positions between the light-shielding heat-dissipating masks 23a, 23b and 23c and the fan 22 and the air vent 25 of the casing 24 mentioned above can also be arranged according to FIG. 3A to FIG. 3C or FIG. 4A to FIG. 4C.

In FIG. 3A to FIG. 3C, the light-shielding heat-dissipating masks 23a, 23b and 23c are still positioned immediately adjacent to the fan 22, wherein the fan 22 is located between the light-shielding heat-dissipating mask 23a, 23b and 23c and the air vent 25 to have the sequential configuration of the light source, the light-shielding heat-dissipating mask 23a, 23b and 23c, the fan, the air vent, which is different from the configuration in FIG. 2A to FIG. 2C.

In FIG. 4A to FIG. 4C, the light-shielding heat-dissipating masks 23a, 23b and 23c are still positioned immediately adjacent to the fan 22, wherein the light-shielding heat-dissipating masks 23a, 23b and 23c are combined with the air vent 25. In such a situation, the outmost surface of each metal sheet of the light-shielding heat-dissipating mask 23a, 23b and 23c may be coated with a heat insulation film (not shown) such as a plastic film in order to prevent users from touching the higher-temperature light-shielding heat-dissipating mask 23a, 23b and 23c directly.

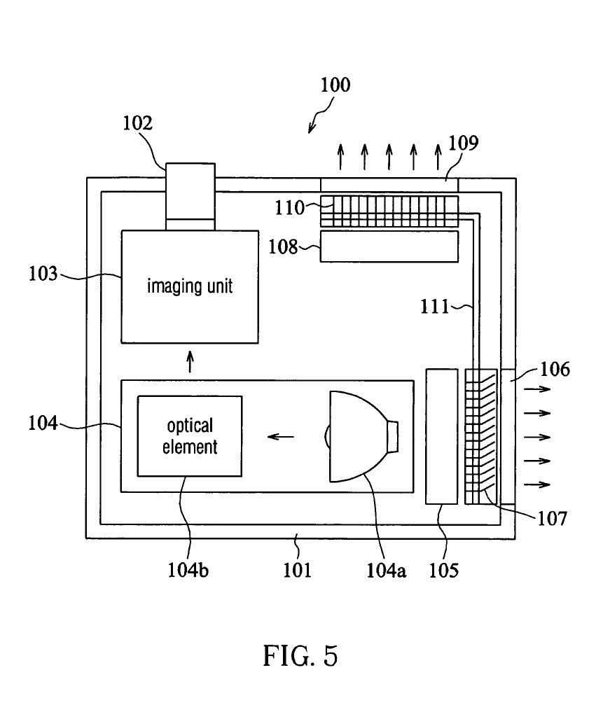

Referring now to FIG. 5, a projector 100 with a light-shielding heat-dissipating mask according to one embodiment of the present invention comprises a casing 101, a projective camera lens 102, an imaging unit 103, an illuminating unit 104, a first fan 105, a first air vent 106, a first light-shielding heat-dissipating mask 107, a second fan 108, a second air vent 109 and a second light-shielding heat-dissipating mask 110.

The imaging unit 103 of this embodiment, positioned in the casing 101, includes at least one light valve (not shown) and a circuit for controlling the imaging of the light valve; the illuminating unit 104 of this embodiment, positioned in the casing 101 as well, includes a light source 104a and an optical element 104b for guiding the light from the light source 104a to the imaging unit 103.

The first fan 105 of this embodiment is positioned behind the light source 104a, and its air-inlet side faces the light source 104a for dissipating the heat generated by the light source 104a; the first air vent 106 is provided on the casing and faces the air-outlet side of the first fan 105; the first light-shielding heat-dissipating mask 107, comprising a plurality of aluminum sheets which have a V-shaped profile and are positioned in the same direction with a fixed gap between adjacent sheets, is positioned immediately adjacent to the first fan 105 for dissipating the heat generated by the light source 104a and preventing the light emitted from the light source 104a from scattering out of the first air vent 106 directly.

The second air vent 109 of this embodiment is positioned on a different side of the casing 101 from the first air vent 106; in addition, the second fan 108 is positioned immediately adjacent to the second air vent 109 with its air-outlet side facing the second air vent 109; furthermore, the second light-shielding heat-dissipating mask 110, comprising a plurality of aluminum sheets, is positioned immediately adjacent to the second fan 108 for dissipating indirectly the heat generated by the light source 104a and preventing the light emitted from the light source 104a from indirectly scattering out of the second air vent 109.

Also, a heat pipe 111 is connected between the first and the second light-shielding heat-dissipating mask 107 and 110. The heat pipe 111 provides the function of conducting the heat absorbed by the first light-shielding heat-dissipating mask 107 to the second light-shielding heat-dissipating mask 110 via the heat pipe 111, followed by exhausting the heat out of the second air vent 109 via the fan 108. Furthermore, the mask 110 provides the function of EMI protection

In this embodiment, the fan 105 may also be positioned between the first light-shielding heat-dissipating mask 107 and the first air vent 106, and the fan 108 may also be positioned between the second light-shielding heat-dissipating mask 110 and the second air vent 109 for the purpose of heat dissipation.

Alternatively, the first light-shielding heat-dissipating mask 107 may be combined with the first air vent 106, and the second light-shielding heat-dissipating mask 110 may be combined with the second air vent 109 for a similar purpose of heat dissipation. In such a situation, the outmost surface of each metal sheet of the light-shielding heat-dissipating mask 107 or 110 may be coated with a heat insulation film such as a plastic film.

On the other hand, a projector 100 with a light-shielding heat-dissipating mask according to one embodiment of the present invention comprising a casing 101, a first fan 105, a first air vent 106, a first light-shielding heat-dissipating mask 107, a second fan 108, a second air vent 109, a second light-shielding heat-dissipating mask 110 and a heat pipe 111 may also be configured as shown in FIG. 5A and FIG. 5B.

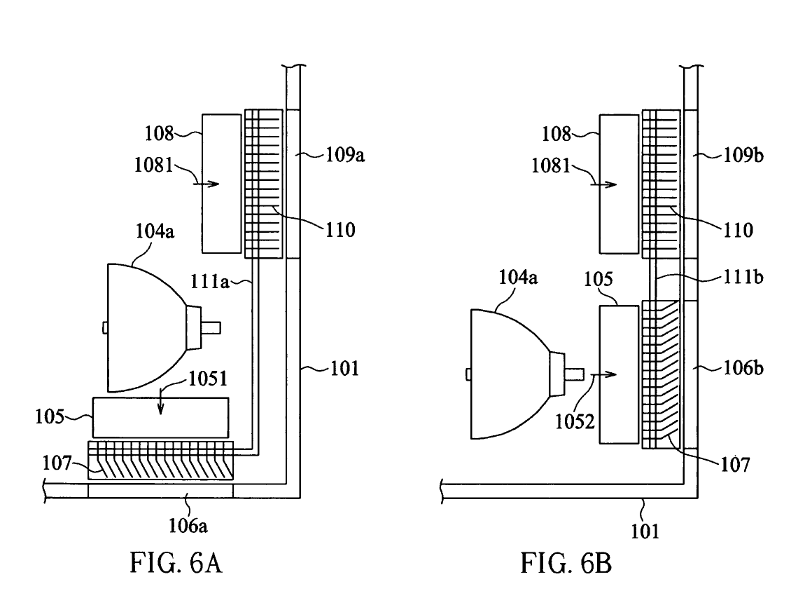

Referring now to FIG. 6A, in a projector with a light-shielding heat-dissipating mask according to one embodiment of the present invention, the first light-shielding heat-dissipating mask 107, comprising a plurality of metal sheets (aluminum sheets in this embodiment) which have a V-shaped profile and are positioned in the same direction with a fixed gap between adjacent sheets, is positioned immediately adjacent to the fan 105 below the light source 104a of the projector for keeping the light emitted from the light source 104a from scattering directly out of the air vent 106a, wherein the air-inlet side of the fan 105 faces the light source 104a for dissipating directly the heat generated by the light source 104a. Besides, the casing 101 of the projector in this embodiment further has an air vent 109a which is far away from the air vent 106a and is located on a different side. A fan 108 whose air-outlet side faces the air vent 109a and a light-shielding heat-dissipating mask 110 are positioned at the air vent 109a. The light-shielding heat-dissipating mask 110, comprising a plurality of metal sheets (aluminum sheets in this embodiment) which have a linear profile and are positioned in the same direction with a fixed gap between adjacent sheets, is positioned immediately adjacent to the fan 108 for keeping the light emitted from the light source 104a from scattering out of the air vent 109a. Moreover, the heat-dissipating end of a heat pipe 111a is connected to the light-shielding heat-dissipating masks 107 and 110, and its heat-absorbing end is positioned in the high-temperature region within the casing 101.

In this embodiment, the heat generated by the light source 104a is exhausted out of the air vent 106a in the arrow direction 1051 as the fan 105 is operating. The heat is directed to dissipate rapidly from the air vent 106a through the gap between adjacent sheets of the light-shielding heat-dissipating mask 107; also, the heat pipe 111a directs a part of the heat to the other light-shielding heat-dissipating mask 110, followed by exhausting the heat out of the air vent 109a in the arrow direction 1081 with the aid of the fan 108. Furthermore, the light emitted from the light source 104a won't scatter to outside via the air vent 106a owing to the bending of V-shaped profile of each metal sheet. It should be noted that the metal-made light-shielding heat-dissipating mask 23b of an arc profile shown in FIG. 2B and the metal-made light-shielding heat-dissipating mask 23c of a linear profile shown in FIG. 2C may be used to replace the light-shielding heat-dissipating mask 107 and achieves the same purposes.

Here, the fan 105 may be positioned between the light-shielding heat-dissipating mask 107 and the air vent 106a, and the fan 108 may also be positioned between the light-shielding heat-dissipating mask 110 and the air vent 109a, which can achieve the purposes of light-shielding and heat-dissipation in a similar way.

Alternatively, the light-shielding heat-dissipating mask 107 may be combined with the air vent 106a, and the light-shielding heat-dissipating mask 110 may be combined with the air vent 109a, which can achieve the purposes of light-shielding and heat-dissipation in a similar way. In such a situation, the outmost surface of each metal sheet of the light-shielding heat-dissipating mask 107 or 110 may be coated with a heat insulation film such as a plastic film.

Referring now to FIG. 6B, in a projector with a light-shielding heat-dissipating mask according to further another embodiment of the present invention, the first light-shielding heat-dissipating mask 107, comprising a plurality of metal sheets (aluminum sheets in this embodiment) which have a V-shaped profile and are positioned in the same direction with a fixed gap between adjacent sheets, is positioned immediately adjacent to the fan 105 behind the light source 104a of the projector for keeping the light emitted from the light source 104a from scattering directly out of the air vent 106b, wherein the air-inlet side of the fan 105 faces the light source 104a for dissipating directly the heat generated by the light source 104a. Besides, the casing 101 of the projector in this embodiment further has an air vent 109b, which is far away from the air vent 106b and is located on the same side. A fan 108 whose air-outlet side faces the air vent 109b and a light-shielding heat-dissipating mask 110 are positioned at the air vent 109b. The light-shielding heat-dissipating mask 110, comprising a plurality of metal sheets (aluminum sheets in this embodiment) which have a linear profile and are positioned in the same direction with a fixed gap between adjacent sheets, is positioned immediately adjacent to the fan 108 for keeping the light emitted from the light source 104a from scattering out of the air vent 109a. Moreover, the heat-dissipating end of a heat pipe 111b is connected to the light-shielding heat-dissipating masks 107 and 110, and its heat-absorbing end is positioned in the high-temperature region within the casing 101.

In this embodiment, the heat generated by the light source 104a is exhausted out of the air vent 106b in the arrow direction 1052 as the fan 105 is operating. The heat is directed to dissipate rapidly from the air vent 106b through the gap between adjacent sheets of the light-shielding heat-dissipating mask 107; also, the heat pipe 111b directs a part of the heat to the other light-shielding heat-dissipating mask 110, followed by exhausting the heat out of the air vent 109b in the arrow direction 1081 with the aid of the fan 108. Furthermore, the light emitted from the light source 104a won't scatter to outside via the air vent 106b owing to the bending of V-shaped profile of each metal sheet. It should be noted that the metal-made light-shielding heat-dissipating mask 23b of an arc profile shown in FIG. 2B and the metal-made light-shielding heat-dissipating mask 23c of a linear profile shown in FIG. 2C may be used to replace the light-shielding heat-dissipating mask 107 and achieves the same purposes.

Here, the fan 105 may be positioned between the light-shielding heat-dissipating mask 107 and the air vent 106b, and the fan 108 may also be positioned between the light-shielding heat-dissipating mask 110 and the air vent 109b, so as to lead to light shield and heat dissipation in a similar way.

Alternatively, the light-shielding heat-dissipating mask 107 may be combined with the air vent 106b, and the light-shielding heat-dissipating mask 110 may be combined with the air vent 109b, which can achieve the purposes of light-shielding and heat-dissipation in a similar way. In such a situation, the outmost surface of each metal sheet of the light-shielding heat-dissipating mask 107 or 110 may be coated with a heat insulation film such as a plastic film.

The above embodiments have described that the present invention utilizes a metal-made light-shielding heat-dissipating mask instead of a traditional plastic-made light-shielding mask in order to find the solution to the aforementioned problems in the prior arts. Since the metal-made light-shielding heat-dissipating mask is manufactured easily and can be made thinner without draft angle problem, the aperture rate of the air vent can be increased. Furthermore, the heat-dissipating efficiency in the projector system is enhanced due to the high thermal conductivity of metal. Also, the metal-made light-shielding heat-dissipating mask is used in company with a metal heat pipe in the present invention, resulting in instant heat conduction and dissipation out of the air vent having a lower temperature, further decreasing the temperature of the air vent. Moreover, the light-shielding heat-dissipating mask and the heat pipe are made of metal, so they can provide the function of EMI protection. It is appreciated that the above-mentioned metal sheets are not confined to aluminum; other metal materials having a good thermal conductivity may also be selected.

While the present invention has been disclosed in terms of several embodiments in detail, it will be appreciated that those skilled in this art should understand the description of each embodiment is exemplary rather than restrictive; that is, various changes and modifications may be made in the invention without departing from the spirit and scope thereof. Therefore, the present invention is defined by the following claims.

1. A light-shielding heat-dissipating mask used in a projector having a light source, a fan and an air vent, comprising:
a plurality of metal sheets, which are positioned at the air vent for dissipating heat generated by the light source and decreasing scatter to outsideing of light emitted from the light source out of the air vent.

2. The mask as claimed in claim 1, wherein each of the plurality of metal sheets has a profile selected from the group consisting of arcs, lines, and V-shapes, and the plurality of metal sheets are positioned in the same direction with a fixed gap between adjacent sheets.

3. The mask as claimed in claim 1, wherein the plurality of metal sheets are connected to at least one end of a heat pipe.

4. The mask as claimed in claim 1, wherein the plurality of metal sheets are aluminum sheets.

5. The mask as claimed in claim 1, wherein the light-shielding heat-dissipating mask is positioned between the fan and the air vent.

6. The mask as claimed in claim 1, wherein the fan is positioned between the light-shielding heat-dissipating mask and the air vent.

7. The mask as claimed in claim 1, wherein the light-shielding heat-dissipating mask is combined with the air vent.

8. The mask as claimed in claim 7, wherein the outmost surface of each of the plurality of metal sheets of the light-shielding heat-dissipating mask is coated with a plastic film.

9. A projector, comprising:
a casing;
an imaging unit, which is positioned within the casing and includes at least one light valve, and a circuit for controlling the imaging of the light valve;
an illuminating unit, which is positioned within the casing and includes a light source, and an optical element for guiding the light from the light source to the imaging unit;
a first fan, which is positioned around the light source, and the air-inlet side of the first fan facing the light source so as to dissipate the heat generated by the light source;
a first air vent, which is positioned on the casing and faces the air-outlet side of the first fan; and
a first light-shielding heat-dissipating mask, which includes a plurality of metal sheets and is positioned immediately adjacent to the first fan for dissipating the heat generated by the light source and decreasing scatter to outsideing of light emitted from the light source out of the first air vent.

10. The projector as claimed in claim 9, wherein each of the plurality of metal sheets has a profile selected from the group consisting of arcs, lines, and V-shapes, and the plurality of metal sheets are positioned in the same direction with a fixed gap between adjacent sheets.

11. The projector as claimed in claim 9, wherein the plurality of metal sheets are connected to at least one end of a heat pipe.

12. The projector as claimed in claim 9, wherein the plurality of metal sheets are aluminum sheets.

13. The projector as claimed in claim 9, wherein the first light-shielding heat-dissipating mask is positioned between the first fan and the first air vent.

14. The projector as claimed in claim 9, wherein the first fan is positioned between the first light-shielding heat-dissipating mask and the first air vent.

15. The projector as claimed in claim 9, wherein the first light-shielding heat-dissipating mask is combined with the first air vent.

16. The projector as claimed in claim 15, wherein the outmost surface of each of the plurality of metal sheets of the first light-shielding heat-dissipating mask is coated with a plastic film.

17. The projector as claimed in claim 9, further comprising:
a second air vent, which is positioned on the casing and far away from the first air vent;
a second fan, which is positioned around the second air vent with an air-outlet side of the second fan facing the second air vent;
a second light-shielding heat-dissipating mask, which includes a plurality of metal sheets and is positioned immediately adjacent to the second fan for dissipating the heat generated by the light source and decreasing scattering of light emitted from the light source out of the first air vent;
at least one heat pipe, whose heat-dissipating end is connected to the first and the second light-shielding heat-dissipating mask, and whose heat-absorbing end is positioned in the high-temperature region within the casing.

18. The projector as claimed in claim 17, wherein the first light-shielding heat-dissipating mask is positioned between the first fan and the first air vent.

19. The projector as claimed in claim 17, wherein the first fan is positioned between the first light-shielding heat-dissipating mask and the first air vent.

20. The projector as claimed in claim 17, wherein the first light-shielding heat-dissipating mask is combined with the first air vent.

21. The projector as claimed in claim 20, wherein the outmost surface of each of the plurality of metal sheets of the first light-shielding heat-dissipating mask is coated with a plastic film.
